(19) United States
(12) Patent Application Publication
(10) Pub. No.: US 2005/0090314 A1
(43) Pub. Date: Apr. 28, 2005

(54) Worldwide casino tour promotion and acceptance system and method

(76) Inventor: George J. Nassef JR., Las Vegas, NV (US)

Correspondence Address: JEFFREY FURR, 253 N. MAIN STREET, JOHNSTOWN, OH, 43031, US

(21) Appl. No.: 10/711,572

(22) Filed: Sep. 25, 2004

Related U.S. Application Data
(63) Continuation-in-part of application No. 10/124,803, filed on Apr. 18, 2002.

(51) Int. Cl. G06F 17/00; G06F 19/00

(52) U.S. Cl. 463/43

(57) ABSTRACT

The invention comprises a method and apparatus for providing an interactive game of chance player (casino player) prospecting exchange service. The method and apparatus enable a gaming service provider's personnel to post promotions on the world wide web for tours and other gatherings of players of interest, search a player database based upon a series of qualifying criteria, and accept electronic reservations for these tours. The method and apparatus further enables a player to identify information that may enable them to qualify themselves based on their play history, types of play and other personal information that may be of interest to a gaming service provider. The method and apparatus further enables a player to be searched from a multiplicity of such players, based upon their travel history. The method and apparatus further enables a player to be searched based upon their desired destination. The method and apparatus further enables a player to be searched based on their preferred games or style of playing games of chance.

### CROSS-REFERENCES TO RELATED APPLICATIONS (IF ANY)

This is a Continuation-in-part of Application Number 10/124803 filed Apr. 18, 2002.

### BACKGROUND

1. Field of the Invention

This invention relates to the art of customer relationship management and, more specifically, to a system for players being provided to a promotion casino establishment by a broker service.

2. Description of Prior Art

Many resources are presently available to services providers in the gaming industry, such as, but not limited to, gaming service providers, such as but not limited to casinos to advertise to players and entice them to visit their establishment. Perhaps the most common method of promotion distribution is direct advertisement to consumers by television, radio or in printed matter, such as but not limited to, newspapers and magazines that are believed to serve those people who may have a specific interest in activities directly related to those services and activities provided by gaming service providers. A typical promotion advertisement will generally include a brief description of the gaming service provider and/or a specific offer, along with the address, telephone number, facsimile number and/or an e-mail address of the gaming service provider when they visit. Gaming service providers typically maintain a host department that is responsible for screening players, identifying the interests of those players and then matching those players with the promotions that best suit their interests and their style of play in games of chance.

Many disadvantages are inherent in this conventional promotion method. For instance, a magazine and especially, a newspaper have a limited number of subscribers and are generally distributed in a limited geographic region. Therefore, a gaming service provider's advertisements may never be seen by many potentially qualified consumers of gaming services outside of that geographical region. In order to distribute the advertisement more efficiently, it may be necessary for gaming service providers to advertise in multiple magazines or on multiple television and/or radio stations, thus substantially increasing the costs related to advertising and promotion of the gaming services provider.

Furthermore, the traditional methods of advertising are and remain very inefficient even after the player's qualifications and interests are made known to the gaming service provider. For example, because a player's skills, financial qualifications and interests must be manually cataloged, organized and screened, an employee in the service provider's hosts department may need to spend a significant amount of time every day performing this task. A large service provider wishing to attract many players on a daily basis will be required to devote significant financial resources employing several people who devote most, if not all, of their time screening, ascertaining and organizing information relating to the qualifications of the players. Furthermore, because a large amount of player information may be received, the task of organizing and screening such information may be particularly onerous and thus, the likelihood that the characteristics and qualifications of the individual players who may be of interest to a gaming service provider may be overlooked and/or mishandled. As a result, a player who is a good match to a gaming service provider and is likely to establish a lifeline relationship with a gaming service provider may be overlooked and never receive promotions or information that is likely to motivate their visiting the gaming service provider's facilities.

Harrahs.com has functions which permit players to view and book complimentary trips or other services which they have already won from a previous visit to the casino online via the web. Their offers are protected by a password/PIN which only the player knows after visiting a casino and signing up for their player's card. The offers are stored electronically for retrieval by the player at a later time. Harrahs and other casinos extend copies of these offers to players via email after they have determined that the player with a past history there qualifies for the special offer.

Some casino public websites have a feature which permits players to sign up (enroll) in the frequent player club and some sites permit players to obtain a plastic player membership card by mail prior to their trip. They are recognized upon arrival at the casino and this function saves them time.

Have web systems which were created as customer systems or add-ons to existing software have internal-use-only websites for their employees, hosts and management's use to view historical play, historical complimentaries, to extend or withdraw offers to players with past play points, redeem player club points, and perform functions which interact with their own customer's with regards to their play at the specific property or within their brand of properties. These systems started out as client-server systems and have been updated to include web functions.

Some casino public websites have a feature which permits a player to view their accumulated play, points or special awards online interactively via the web, or to view special room rates which have been discounted for their level of play or frequency of visit.

In an attempt to increase the scope of their advertising, some gaming service providers have begun using computer networks, including the Internet, to post promotions. For instance, a casino may set up its own “home page” on the World Wide Web (the “Web”) on which various promotions can be posted. Anyone who accesses the Internet can thus access or “log on” to a service provider's home page, determine which promotions are available, and send contact information to the company via regular mail, facsimile or e-mail.

While an Internet or web site home page may be a useful tool for a gaming service provider to expand its advertising capabilities, a home page provides no mechanism for organizing or screening player information and qualifications that a player may choose to provide. The received contacts still must be organized and screened by an employee in the casino's host department in the traditional manner. Hence, the possibility still exists that a contact will be overlooked, mishandled or lost.

Furthermore, in order for a prospective player to have access to the service provider's promotions, the player must be aware that the service provider's facilities exist and that the service provider has an Internet home page on the Web. Hence, if a player has never heard of the service provider's facility, the player would not be aware that gaming service provider has a home page. Many highly qualified players therefore may overlook the service provider's promotions because they simply are not aware that the gaming service provider's facilities exist.

In order to assist a gaming service provider's consumer prospecting efforts, tools have been deployed to screen players' qualifications which can be configured so as to discriminate to the characteristics of many players for the purposes of ascertaining the most qualified, and thus, the most-desirable players. Player profiles that are received by a gaming service provider who uses this software uploaded this information to a computer for storage and retrieval on an as-needed basis. The computer running the profile screening software can then be controlled to search those profiles for various attributes, such as previous play levels, locations of play, the home location of the player, personal play description and other information of interest to the gaming service provider. The computer will then provide a list of the most-qualified candidates from the entire collection of player profiles. This computerized screening and sorting method reduces the overhead expense of a gaming service provider and allows human resources to devote more time to other tasks.

However, known profile screening software does not assist gaming service provider's personnel in advertising promotions. Although the profile screening software is useful once a profile has been received by the casino, it provides no advantage in enabling the casino to seek out the most-qualified TV, radio, newspaper, magazines, etc.) in order to obtain a set of players qualifications. Hence, the drawbacks associated with those types of advertising methods have not been resolved.

Therefore, a continuing need exists for a system which will maximize the scope of a gaming service provider's advertising efforts while also providing a reasonably secure and efficient manner of forwarding profiles to a gaming service provider and, thus, enabling the gaming service provider to efficiently screen and categorize the profiles received. Additionally, a continuing need exists to assist a player seeker in locating available promotions quickly and effectively.

The need for a better method for implementing casino junkets or casino tours to potential or return customers and tracking the acceptance of those promotions via electronic means shows that there is still room for improvement within the art.

### SUMMARY OF THE INVENTION

The current invention is a system and method for implementing casino junkets or casino tours to potential or return customers and tracking the acceptance of those promotions via electronic means. Data including promotions and requirements for the promotion are entered online in real-time by casino representatives into the real-time posting system and presented, based upon certain player qualifications, in real-time to qualified players. Promotions are displayed to potential customers based upon customer preference items, applicable dates of the promotion, qualification of the potential customer to maintain play and minimum play levels required to qualify for the casino tour and if displayed are able to be accepted by the potential customers, with notification back to the casino tour operator electronically via the system.

The invention provides a computer and software program, recorded on a computer-readable medium, for controlling the computer of a potential junket to maintain and generate a listing of players, maintain important rules of the trade, rules specific to the destinations and business logic of the expected transaction. The software program interacts with the database of information and applies the business rules to create lists of players, alerts, emails, and other data that can be accessed via the Internet. Specifically, the software program is adapted to be run by a representative's computer to control the computer to generate a computer readable file (junket file) that includes information pertaining to players, trips, contacts, companies, and transactions that can be accessed from a remote site via the Internet. For example, these files can be posted as a Web site on the World Wide Web.

An object of the present invention is to provide a method and apparatus which enables a gaming service provider to advertise its services and promotions on a global computer information network, such as the Internet, and to directly receive player qualifications from prospective players, and to efficiently ascertain and organize the information that a player transmits to the gaming service provider.

A further object of the present invention is to provide a method and apparatus which monitors promotions transmitted to an individual player and automatically notifies the player when a promotion for which the player is interested in and qualified for becomes available.

A further object of the present invention is to provide a method and apparatus which enables a plurality of gaming service providers to advertise promotions at a single location accessible via a global computer information network, such as the Internet. A further object of the present invention is to provide a method and apparatus which enables both new and pre-qualified players to access the promotions of a group of gaming service providers via a global computer information network. A further object of the present invention sis to provide a method and apparatus which enables both new and pre-qualified players who, once having accessed the promotions of a group of gaming service provider's promotions, to be able to disconnect a player from the single global computer information network location while enabling the player to communicate directly with particular gaming service provider via the global computer information network when a player selects an available promotion at that gaming service provider's facility or casino.

The above objects are substantially achieved by providing a computer, a software program, recorded on a computer-readable medium, for controlling the computer of a potential gaming service provider to generate a listing of appropriate players for the service provider and the available promotions that can be accessed via the Internet. Specifically, the software program is adapted to be run by a gaming service provider's computer to control the computer to generate a computer readable file (promotion file) that includes information pertaining to available promotions and which can be accessed from a remote site via the Internet. For example, the promotion file can be posted as a Web site on the World Wide Web. A player can access the Web site and search the information in the promotion file for a desired offer.

Also, all or selected portions of the promotion file can be uploaded to a remote site computer to link the promotion file to a computer readable file, such as a remote Web site, that is hosted by the remote computer. Players can access the remote Web site and search the uploaded portion of the promotion file for a desired promotion. The remote computer is also capable of automatically searching the uploaded portion of the promotion file for data that matches data provided by the player and is capable of informing the player's computer by an electronic message sent via the Internet when a match for an appropriate promotion is found.

Furthermore, the portion of the promotion file which includes more detailed information about the available promotions is maintained by the service provider's computer instead of by the remote site. Hence when a player chooses to explore this additional information, the player's computer is disconnected form the remote site, and reconnected to a new site which possesses this additional information that has been provided to that site by the computer of the gaming service provider offering the promotion. The promotion file further includes linking data which enables the player's computer to send an electronic message, such as, but not limited to, an e-mail, or instant message, to the gaming service provider's computer and vice-versa via a global computer information network or wireless transmission network, such as the Internet. As additional objects and modifications of the present invention will be apparent to one skilled in the art, the object, forms and embodiments of the invention are not limited by the foregoing statements.

The current invention can utilize the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its
raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows data being inputted into the system by a player;

FIG. 2 displays a promotion being forwarded to a player;

FIG. 3 shows an overview of how a User accesses the system through the Internet;

FIG. 4 shows a sample of users computer connecting to the system;

FIG. 5 shows the system sending a message to a player/representative; and

FIG. 6 displays the promotion file.

### DESCRIPTION OF THE PREFERRED EMBODIMENT

The following description is demonstrative in nature and is not intended to limit the scope of the invention or its application of uses.

There are a number of significant design features and improvements incorporated within the invention.

The current invention is a system and method implementing casino junkets or casino tours and promotions to potential or return customers and tracking the acceptance of those promotions via electronic means.

The invention comprises a method and apparatus for providing an interactive game of chance player (casino player) prospecting exchange service. The method and apparatus enable a gaming service provider's personnel to post promotions on the World Wide Web for tours and other gatherings of players of interest, search a player database based upon a series of qualifying criteria, and accept electronic reservations for these tours. The method and apparatus further enables a player to identify information that may enable them to qualify themselves based on their play history, types of play and other personal information that may be of interest to a gaming service provider. The method and apparatus further enables a player to be searched from a multiplicity of such players, based upon their travel history. The method and apparatus further enables a player to be searched based upon their desired destination. The method and apparatus further enables a player to be searched based on their preferred games or style of playing games of chance.

The invention further comprises a method and apparatus for providing an interactive computer-driven (web exchange, web site) player prospecting service. The method and apparatus enables a gaming service provider to advertise available promotions on the Internet, directly receive queries from prospective players (a gamer or gambler), and efficiently organize and screen the received player's play history, games of interest, and other information that may be available to the gaming service provider. The method and apparatus is further capable of monitoring gaming service provider promotions and automatically notifying the player when a promotion for which the player is qualified and/or interested in is made available by the gaming service provider. The method and apparatus further enables a plurality of companies to advertise promotions at a single location accessible via a global computer information network, such as the Internet by a player and enables the player to communicate directly with a gaming service provider facility, such as a casino, via the Internet if the player is interested in further information pertaining to a gaming service provider or casino.

It is a system 1 and method for implementing casino junkets, casino tours or casino promotions to potential or return customers and tracking the acceptance of those promotions via electronic means. Junket information is accumulated at each junket operator's business through one or more LAN-based data entry systems, including but not limited to browsers, updated to a central database that is connected to each tour operator's systems through one or more WANS.

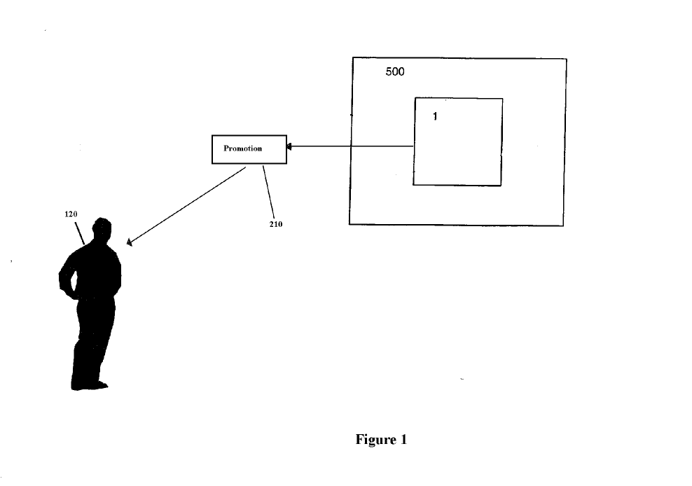

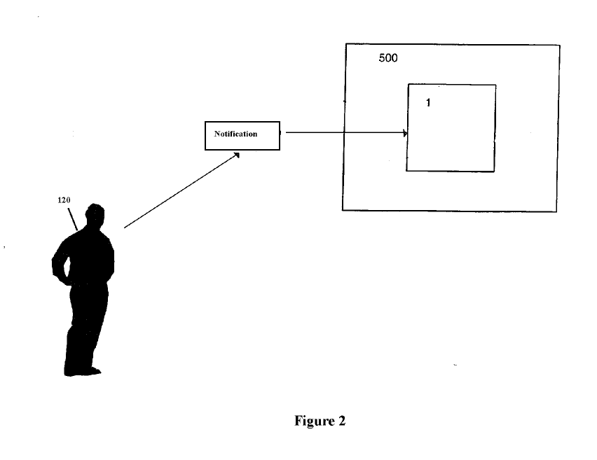

As shown in FIG. 1, data can include promotions and requirements for the promotion are entered online in real-time by casino representatives into the real-time posting system and presented, based upon certain player qualifications, in real-time to qualified players 120. Promotions 210 are displayed to potential customers/players 120 based upon player's inputted data such as customer preference items, applicable dates of the tour, qualification of the potential customer to maintain play and minimum play levels required to qualify for the casino tour and if displayed are able to be accepted by the potential customers, with notification back to the casino tour operator electronically via the system as shown in FIG. 2.

The system 1 is a computer-implemented method for posting, presenting, updating and removing from a system: casino tours, junkets, and free stays at a casino property and electronically capturing the acceptance of interested players 120: The system 1 provides for the real-time placement of casino tours, promotions and junkets.

Using a structure methodology, the system 1 determining the best tour to display to potential clients based upon travel dates, desired destination, subjective information inputted by the player 120 including past play, address information, and willingness to play at a particular level of play.

The system 1 will electronically indicate in real-time to the casino representative that a potential player 120 intends to accept a tour; representing arrival and departure information on players 120.

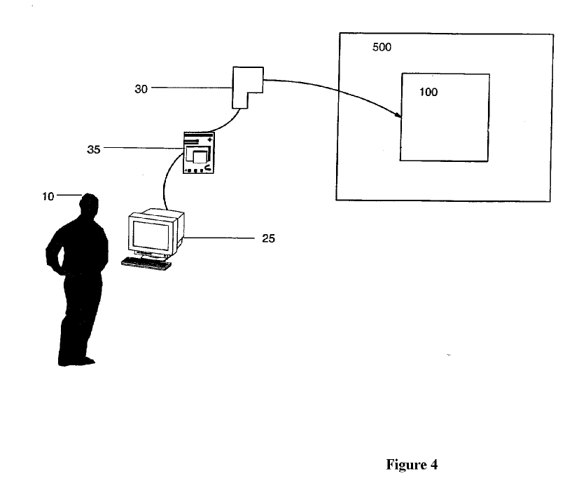

As shown in FIG. 4, the present invention comprises a computer 25 with the software 35 program recorded on a computer-readable medium 30, for controlling the computer of a potential junket to maintain and generate a listing of players, maintain important rules of the trade, rules specific to the destinations and business logic of the expected transaction. The software program interacts with the database 310 of information and applies the player's preferences to create lists of players, alerts, emails, promotions and other data that can be accessed and tracked via the Internet. Specifically, the software program is adapted to be run by a representative's computer to control the computer to generate a computer readable file (junket file) that includes information pertaining to players, trips, contacts, companies, and transactions that can be accessed from a remote site via the Internet 500. For example, these files can be posted as a Web site 100 on the World Wide Web 500.

The present invention comprises a method and apparatus for providing a game of chance player 120, such as a casino player 120, customer relationship management system for players 120 serviced within a business that are being provided to a casino establishment by an independent broker (called an operator, independent representative or “junket”) service. More specifically, the present invention relates to a method and apparatus which enables junket representatives of a casino service provider to record all aspects of the relationship of a player 120 during the prospecting, qualifying, closing, purchasing of services, and post-trip service process by maintaining a database 310 of phase and state information pertaining to the transaction used in the business to introduce players 120 to their facility. The current invention accomplishes this via a global computer information network, such as the Internet 500, to record data relevant to the transaction while enforcing a series of business rules which must be followed during the transaction as defined by the junket's business operation. These rules must be followed to satisfy certain legal, regulatory or common-sense guidelines during the booking process and are inherent in the system.

The present invention further enables junket personnel to use the Internet 500 to offer a promotion, manage the transaction, perform reporting, create graphical representations of the process, the value of the transactions, the destinations and relative business being formed at each of the junket's business destinations or offices, verify staff and internal personnel performance, create graphs and other reports both online and offline on the relative performance of customer service personnel performing the functions on the part of the junket or promotion 210.

The computer application that includes the user interface for this invention will henceforth be referred to as the “System 1.” The system is network-based and works on an Internet, Intranet and/or Wireless network basis as well as a stand-alone and fax-based system.

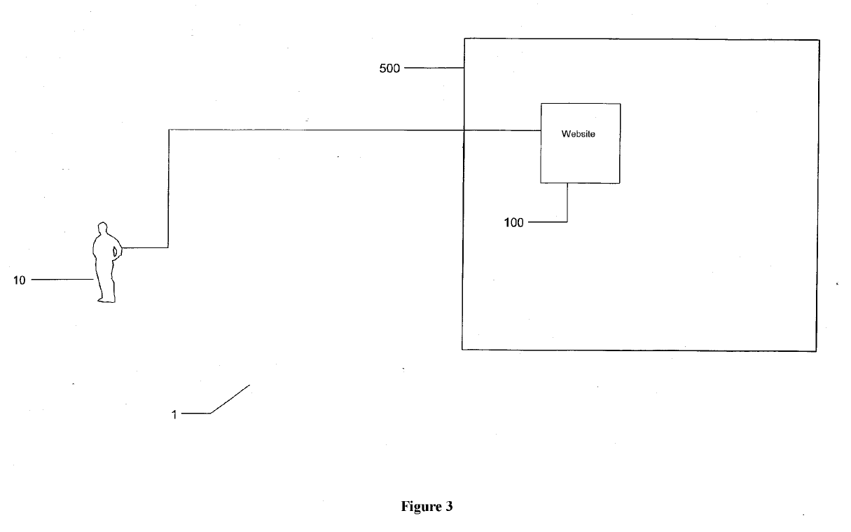

FIG. 3 illustrates a functional diagram of a computer network for World Wide Web 500 access to the System 1 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, or American Online, etc. or Wireless devices using services like AT&T or Verizon.

The Users 10 contact the System Web Site 100 using an informational processing system (Client) capable of running an HTML compliant Web browser such as Microsoft's Internet Explorer, Netscape Navigator, Lynx or Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 and/or Service Providers 20 connect to the System Web Site 100. In the preferred embodiment the system has numerous web pages. The information in the web pages are in HTML format via the HyperText Transport Protocol (http) and on Server System database 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System database 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The system 1 is set to run on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The computing device can serve as a server.

The invention comprises a method and apparatus for providing a game of chance player customer relationship management system for players 120 serviced within a business that are being provided to a casino establishment by an independent broker service.

The system 1 enables junket representatives to record data relevant to the transaction of delivery of players 120 to casinos including, but not limited to: the stages of the booking process, desired dates of travel, desired casino play, past play, past casino trips, desired travel, qualifying information, personal data, pictures, methods of transportation, personnel greeting and meeting information, alerts, probability of travel coming to fruition, charges related to the trip, credit and front-money requirements for the trip, arrival and departure dates, nightclub and other entertainment information, personal travel companions, spouse information, group leaders and other attributes associated with the other individuals joining the junket trip, percentages of commissions to be payable to the junketeer upon completion of the trip, actual commissions received by the junketeer for past trips by the same player 120, confirmation of itinerary, itinerary generation, automatic generation of specific reservations information required by the target property or casino destination, electronic verification and self-service features for players to self-confirm travel booking completion, wholesale costs of services provided along the trip, and feedback from customers collected during the course of interaction between the system and the player 120 during the booking process or following the trip. These items are stored on the system's database 310. The system 1 offers promotions 210 and information that maximizes casino play and travel.

Junket staff members or casino staff members as Users 10 can search this collection of data from the database using a series of qualifying criteria or context criteria, including booking phase, demographics, destination, profit and loss, play history, and other personal information that may be of interest to a junket organization to offer promotions.

The system 1 further enables a player 120 to be searched from a multiplicity of such players, based upon their play or travel history. The method and apparatus further enables a player 120 to be searched based upon their desired destination. The method and apparatus further enables a player 120 to be searched based on their preferred games or style of playing games of chance. Standard search methodology that is commonly known in the art is used.

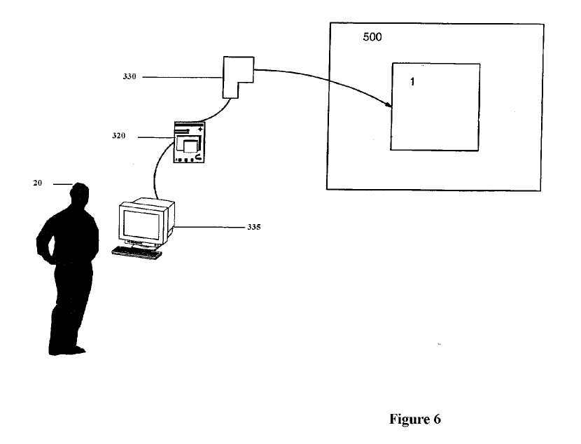

In the preferred embodiment, as shown in FIG. 6 the system 1 is a software program 320, recorded on a computer-readable medium, for controlling the computer 35 of a potential gaming service provider to generate a listing of appropriate players 120 for the service provider 20 and the available promotions that can be accessed via the Internet 500. Specifically, the software program 320 is adapted to be run by a gaming service provider's computer to control the computer 35 to generate a computer readable file, the promotion file 330, that includes information pertaining to available promotions 210 and which can be accessed from a remote site via the Internet 500. For example, the promotion file can be posted as a Web site on the World Wide Web. A player can access the Web site and search the information in the promotion file 330 for a desired offer.

Also, all or selected portions of the promotion file 330 can be uploaded to a remote site computer 335 to link the promotion file 330 to a computer readable file, such as a remote Web site, that is hosted by the remote computer 335. Players 120 can access the remote Web site and search the uploaded portion of the promotion file 330 for a desired promotion 210. The remote computer 335 is also capable of automatically searching the uploaded portion of the promotion file 330 for data that matches data provided by the player 120 and is capable of informing the player's computer 45 by an electronic message sent via the Internet 500 when a match for an appropriate promotion is found.

Furthermore, the portion of the promotion file 330 which includes more detailed information about the available promotions 210 is maintained by the service provider's computer instead of by the remote site. Hence when a player 120 chooses to explore this additional information, the player's computer 45 is disconnected form the remote site, and reconnected to a new site which possesses this additional information that has been provided to that site by the computer of the gaming service provider offering the promotion. The promotion file further includes linking data which enables the player's computer to send an electronic message, such as, but not limited to, an e-mail, or instant message, to the gaming service provider's computer and vice-versa via a global computer information network or wireless transmission network, such as the Internet 500. As additional objects and modifications of the present invention will be apparent to one skilled in the art, the object, forms and embodiments of the invention are not limited by the foregoing statements.

The system 1 will enable the representative, player or casino service personnel, as a User 10, to use this score against a series of criteria (rules) that match the casino service providers desired customers for a specific future travel data specified by the representative, player or casino service personnel. This allows the representative, player or casino service personnel to concentrate on those players 120 that match specific criteria.

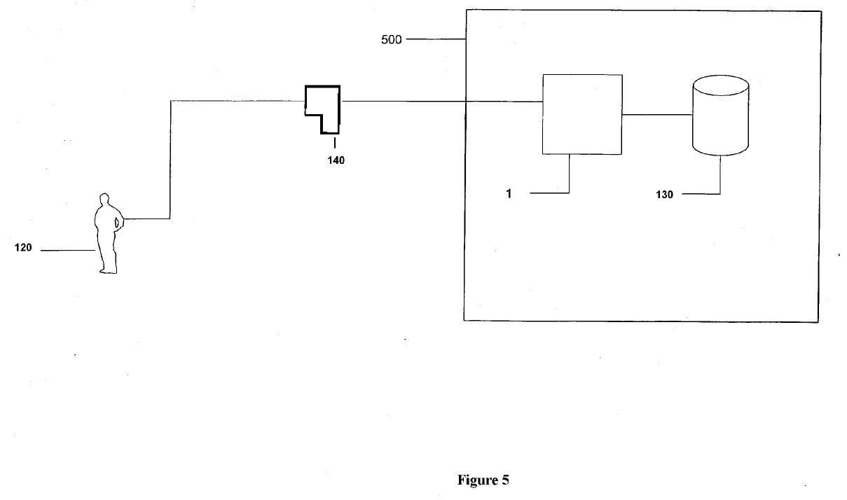

The system 1 is connected to other databases and computer systems, such as hotel reservation systems 130, allowing it the capable of monitoring gaming service provider hotel inventories, gaming space, and desired gamers and notifying the player 120 when a casino service provider has openings for which the player is qualified and/or interested in is made available by the gaming service provider. The system 1 can notify the player 120 and/or the service provider 20 through E-mail, mail, phone, fax or any other means of communications 140 as shown in FIG. 5.

The system 1 allows a plurality of casino service providers, representatives, and players 120 as users 10 to interact at a single location accessible via a global computer information network. The system 1 has a communications function that further enables a player and the junket representative to communicate directly with a gaming service provider facility, such as a casino, via the Internet if the player is interested in completing the plans for the player's next experience at the gaming service provider's facility (booking).

The system 1 provides a method and apparatus which enables both new and pre-qualified players to access the current or historical status of the interactions via a global computer information network. The system 1 can be used by junket representatives and casino marketing who deal solely with representatives.

The system 1 allows a plurality of casino service providers to monitor the transactions and automatically notifies the junket representative and casino when a promotion is appropriate to be offered.

The system 1 differs from prior art as the current invention takes permits players without a play history at a casino, or a proven play history at other casinos to view, retrieve and book complimentaries and other services at a new brand or property where they have never played. The current invention uses subjective information supplied by the player to qualify and verify their ability to play at the subjective level, applies our rules for a specific property or brand, then displays the list of offers for which they qualify during a particular set of trip dates, in their native language, at a particular destination or destinations.

The system 1 in the preferred embodiment will communicate with the players 120 in their native language.

Advantages

The previously described version of the present invention has many advantages. It provides a system for providing a game of chance player (casino player) customer relationship management system for players, it provides a method and apparatus to offer promotions to the players, it provides a method and apparatus which enables a plurality of junket providers/gaming service providers to manage a plurality of players via a global computer information network, and it provides a method and apparatus which enables both new and pre-qualified players to access the current or historical status of the interactions via a global computer information network

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. What is claimed is:
A customer relationship management system comprising:
having a database;
having said database contain data about a gaming player; and
allowing said data to be accessed by users of the system being use to offer promotions to said player.

2. A customer relationship management system of claim 1 further comprising having said system being accessible by a user through the Internet.

3. A customer relationship management system of claim 1 further comprising having said data being historic data of said gaming player.

4. A customer relationship management system of claim 3 further comprising having said historic data being the gaming history of said gaming player.

5. A customer relationship management system of claim 1 further comprising having said data being the preferences of said gaming player.

6. A customer relationship management system of claim 1 further comprising having said system connecting to other database systems.

7. A customer relationship management system of claim 6 further comprising having said promotions written in a player's native language.

8. A customer relationship management system of claim 1 further comprising having said system contacting said gaming player about a promotion.

9. A customer relationship management system of claim 8 further comprising where said gaming player is contacted based on a selection criteria.

10. A customer relationship management system of claim 1 further comprising where said database has a promotional file that contains information about the player and the promotions.

11. A customer relationship management system of claim 10 further comprising where said promotions are forwarded to a player based on selection.

12. A customer relationship management system comprising:
having a database on which a promotion file resides;
having said promotion file contain data about a gaming player;
having said promotion file contain information about promotion, and
allowing said data to be accessed by users of the system being use to offer promotions to said player.

13. A customer relationship management system of claim 12 further comprising having said system being accessible by a user through the Internet.

14. A customer relationship management system of claim 12 further comprising having said data being historic data of said gaming player.

15. A customer relationship management system of claim 12 further comprising having said data being the preferences of said gaming player.

16. A customer relationship management system of claim 12 further comprising having said system connecting to other database systems.

17. A customer relationship management system of claim 12 further comprising having said promotions written in a player's native language.

18. A customer relationship management system of claim 12 further comprising having said system contacting said gaming player about a promotion.

19. A customer relationship management system of claim 12 further comprising where said gaming player is contacted based on a selection criteria.
